(19) United States
(12) Patent Application Publication
(10) Pub. No.: US 2026/0368564 A1
(43) Pub. Date: Nov. 19, 2026

(54) Multi-System Orchestration by Artificial Intelligence Agents

(71) Applicant: ServiceNow, Inc., Santa Clara, CA (US)

(72) Inventors: Yaron Lehmann, Sunnyvale, CA (US); Danica Shei, San Francisco, CA (US); Gabby Menahem, Santa Clara, CA (US); Dror Mann, New York, NY (US); Matthew Heidemann, Denver, CO (US)

(21) Appl. No.: 19/207,647

(22) Filed: May 14, 2025

(51) Int. Cl. G06N 5/043

(52) U.S. Cl. CPC G06N 5/043

(57) ABSTRACT

A method includes receiving, using a multi-agent controller, a user query. The method also includes identifying, using the multi-agent controller, a plurality of artificial intelligence (AI) agents for responding to the user query. The plurality of AI agents may include (i) a first AI agent associated with a first platform and (ii) a second AI agent associated with a second platform that is different from the first platform. The method additionally includes generating, using the multi-agent controller and based on operations of the plurality of AI agents, output data responsive to the user query.

### BACKGROUND

Artificial intelligence (AI) agents may be provided by computing systems for performing various tasks, such as investigating and/or facilitating resolution of technical issues. In some cases, a given task might not be performable and/or able to be completed using a single AI agent, and may instead involve using multiple different AI agents.

### SUMMARY

Each respective computing platform (“platform” for short) of a plurality of computing platforms may provide one or more artificial intelligence (AI) agents. These AI agents may be configured to perform tasks related to the functionality provided by the respective computing platform (e.g., assisting with investigating technical issues arising in connection with the respective computing platform). The AI agents of the respective computing platform may be organized into two or more agent teams, and the AI agents of a given team may be configured to perform different aspects of a particular type of task (i.e., the agent teams may be organized around task-specialization). For example, a performance monitoring agent team may include a plurality of AI agents configured to monitor, report on, and/or improve the performance of computing devices within a network. In some cases, the respective AI agent may be configured to invoke execution of one or more software tools for performing corresponding tasks. Operation of the AI agents of the respective computing platform may be coordinated by a coordinator agent, which may be configured to develop at least part of a plan for addressing an input query (e.g., user query) and coordinate operation of the AI agents to execute the plan.

In some cases, the input query might not be addressable and/or resolvable without using the AI agents provided by multiple different computing platforms. For example, when aspects of multiple different computing platforms are used by a single software application, investigation and/or resolution of an error encountered by the software application may involve different AI agents provided by the multiple different platforms. However, the AI agents of different computing platforms might not be interoperable with one another. For example, these AI agents might not be communicatively interconnected (and thus might not be aware of one another), might use different data formats for exchanging information (and thus might not understand each other very well), and/or may rely on different types of information for performing the operations thereof (and thus might fail to produce useful results when this information is not provided), among other factors.

Thus, a multi-agent controller may be provided as part of at least one computing platform to facilitate interoperability of different AI agents across different computing platforms. The multi-agent controller may be configured to discover a plurality of AI agents available across the plurality of computing platforms, thus making the plurality of AI agents available and interoperable for responding to user queries. For example, when the multi-agent controller is part of a first computing platform of the plurality of computing platforms, the multi-agent controller may allow both AI agents available from the first computing platform and AI agents available from other (third-party) computing platforms to be used in responding to user queries originating from the first system.

The multi-agent controller, the various AI agents, and the coordinator agents may use a standardized data format for communicating with one another, thus facilitating discovery of and data exchange among the various AI agents. The multi-agent controller may be used to route various communications (represented using the standardized data format) between two or more different computing platforms. The communications may include (i) textual discovery messages related to discovery of the various AI agents across the two or more different computing platforms and (ii) textual conversation messages representing intermediate results generated by the various AI agents in addressing the input query. In some cases, the communications may include context data associated with the input query (e.g., attributes of the user that provided the user query, a web page being viewed by the user while providing the user query, etc.), user preferences and/or customizations specified by the user for interacting with AI agents, and/or memories associated with (i) the input query and/or (ii) prior user queries of the user, among other possibilities.

Accordingly, a first example embodiment may involve receiving, using a multi-agent controller, a user query. The first example embodiment may also involve identifying, using the multi-agent controller, a plurality of AI agents for responding to the user query. The plurality of AI agents may include (i) a first AI agent associated with a first platform and (ii) a second AI agent associated with a second platform that is different from the first platform. The first example embodiment may further involve generating, using the multi-agent controller and based on operations of the plurality of AI agents, output data responsive to the user query

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include a processor configured to perform operations in accordance with any of the previous example embodiments.

In a fifth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts an arrangement of agentic resources provided by a plurality of different computing platforms, in accordance with example embodiments.

FIG. 7A is a message flow diagram that depicts aspects of a discovery process of agentic resources, in accordance with example embodiments.

FIGS. 7B and 7C are message flow diagrams that depict aspects of using agentic resources to address an input query, in accordance with example embodiments.

FIGS. 8A, 8B, and 8C depict aspects of a data format for exchanging information among agentic resources, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is how to allow the AI agents of different computing platforms to cooperate and/or collaborate with one another in addressing input queries. In practice, this is problematic because the AI agents of different computing platforms may use different communication protocols and/or standards when communicating with one another, and/or different terminology and/or data formats when describing aspects of the solutions to the input queries.

In other techniques, a user might provide separate input queries to the AI agents of different computing platforms. However, these techniques do not allow the AI agents to communicate, collaborate, and/or cooperate with one another. Moreover, such approaches rely on subjective decisions and experiences of the users providing the separate queries to the different computing platforms, which leads to wildly varying outcomes from instance to instance. Thus, other techniques did little if anything to address the need for automating cross-platform collaboration of AI agents.

Further, an AI agent of a first computing platform could be provided with information about an application programming interface (API) of a second computing platform, and tasked with (i) learning how to use this API and (ii) using this API to assist with addressing tasks. However, the AI agent may lack familiarity with and/or expertise in the second computing platform, and thus might not be able to use this API very effectively. For example, AI agents that form part of (and are thus more familiar with) the second computing platform may be more effective at operating with respect to the second computing platform than the AI agent using the API. Additionally, the API could change over time, resulting in errors when using the API and/or the AI agent having to re-learn how to use the API, which may cause excessive processor utilization, inflated memory allocations, repeated network transmissions, and/or increased power consumption.

The AI agent of the first computing platform could also communicate with AI agents of the second computing platform using platform-specific and/or AI-agent-specific APIs provided by the second computing platform. However, such APIs might limit the amount of information that can be shared among AI agents (e.g., might not be intended and/or configured for agent-to-agent interactions and/or collaboration) and/or might necessitate ongoing updates to the AI agent of the first computing platform (e.g., to keep up with changes to the APIs), making this arrangement less efficient at addressing queries and/or morel likely to encounter errors (thus also incurring excessive processor utilization, inflated memory allocations, repeated network transmissions, and/or increased power consumption).

The embodiments herein overcome these limitations by providing a multi-agent controller that (i) dynamically discovers the agentic resources available across different computing platforms and (ii) facilitates interactions among the AI agents of different computing platforms. In this manner, input query resolution can be accomplished in a more accurate and robust fashion. This results in several advantages. First, the AI agents of different computing platforms can automatically collaborate with one another on a single input query without depending on users for coordinating the operations of the AI agents of different computing platforms. Second, the multi-agent controller can facilitate adherence to a standardized data serialization format among the AI agents of the different computing platforms, thus allowing these AI agents to better understand one another and provide the information that each AI agent uses to operate.

Third, failed or incomplete input query resolution can trigger multiple retry cycles, resulting in excessive processor utilization, inflated memory allocations, repeated network transmissions, and/or increased power consumption. By incorporating AI agents that accurately interpret, route, and autonomously adapt to incoming requests, the system obviates extensive retries. As a result, processor cycles, memory footprint, network bandwidth, and overall power demand are reduced, thereby improving the efficiency and scalability of the system.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise’s ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise’s operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise’s custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise’s network and used to manage such a network. The following embodiments describe architectural and functional aspects of example aPaaS systems, as well as the features and advantages thereof.

### III. Example Computing Devices and Cloud-Based Computing Environments

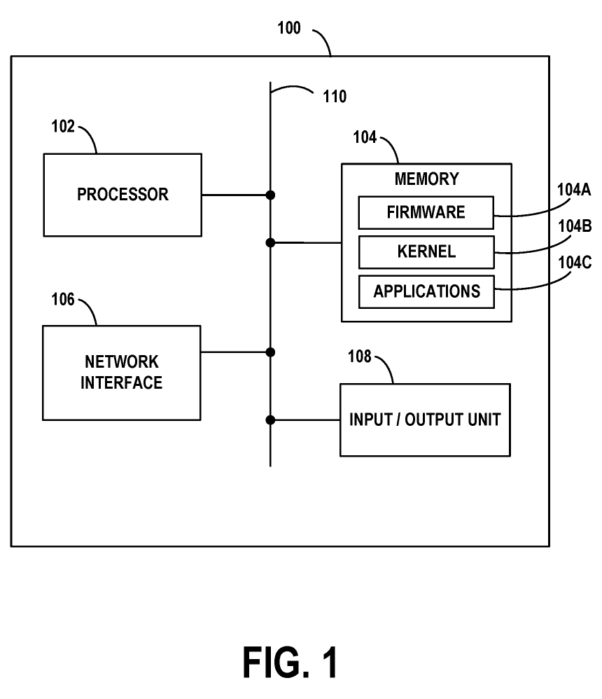

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input / output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input / output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input / output unit 108 may facilitate user and peripheral device interaction with computing device 100. Input / output unit 108 may include one or more types of input devices, such as a keyboard, a mouse, a touch screen, and so on. Similarly, input / output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

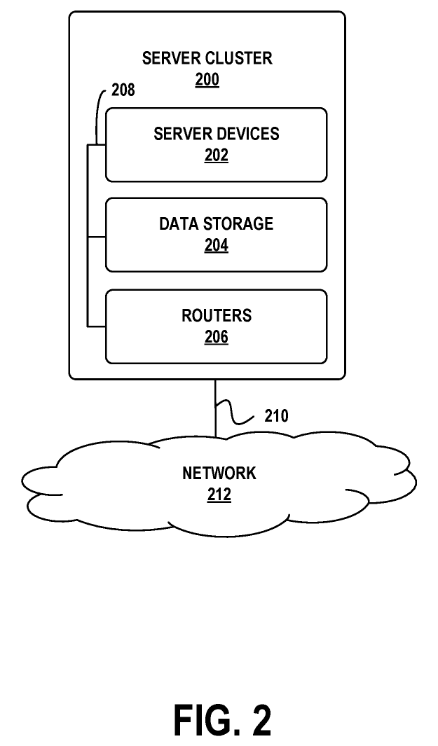

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

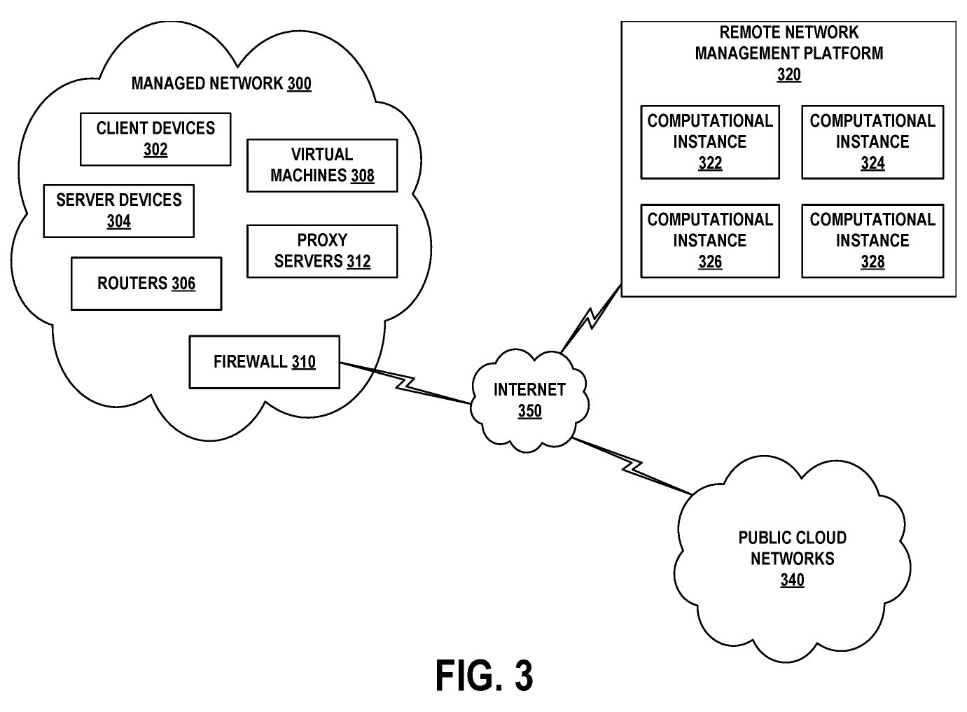

FIG. 3 depicts a remote network management architecture, in accordance with example embodiments. This architecture includes three main components – managed network 300, remote network management platform 320, and public cloud networks 340 – all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers’ data are separate from one another, the separation is enforced by the software that operates the single database. As a consequence, a security breach in this system may affect all customers’ data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer’s instance experiences an outage due to errors or an upgrade, other computational instances are not impacted. Maintenance down time is limited because the database only contains one customer’s data. Further, the simpler design of the multi-instance architecture allows redundant copies of each customer database and instance to be deployed in a geographically diverse fashion. This facilitates high availability, where the live version of the customer’s instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

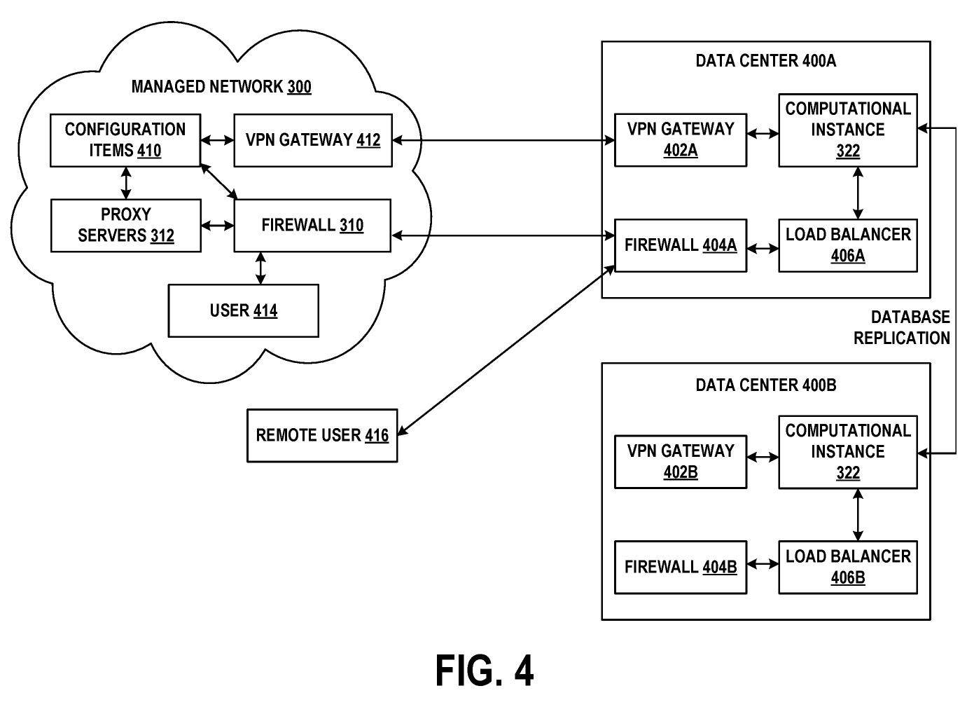

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0 – 10.255.255.255 or 192.168.0.0 – 192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

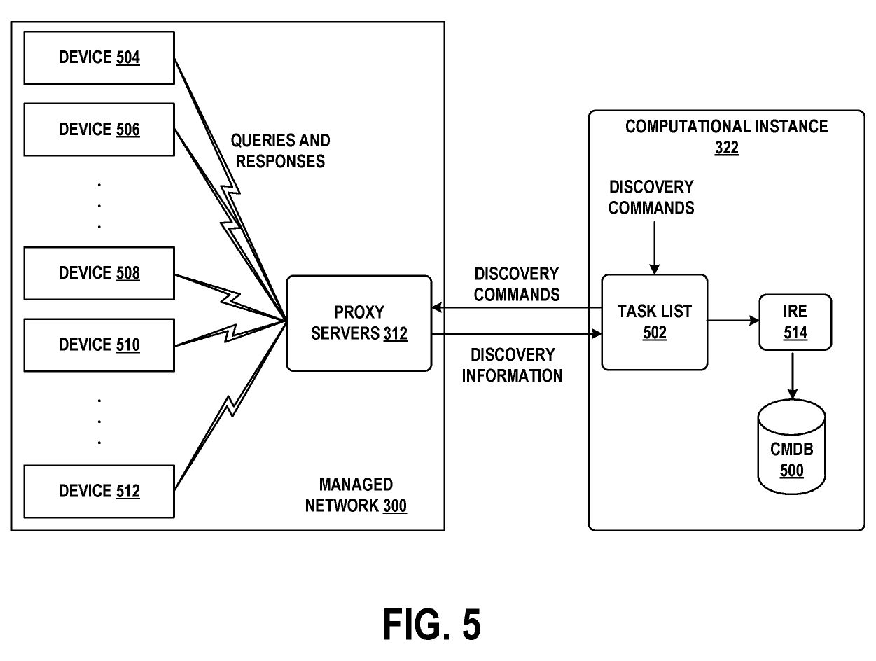

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid / password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery – horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input / output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router’s network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases – under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices – for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item’s attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example AI Agent System

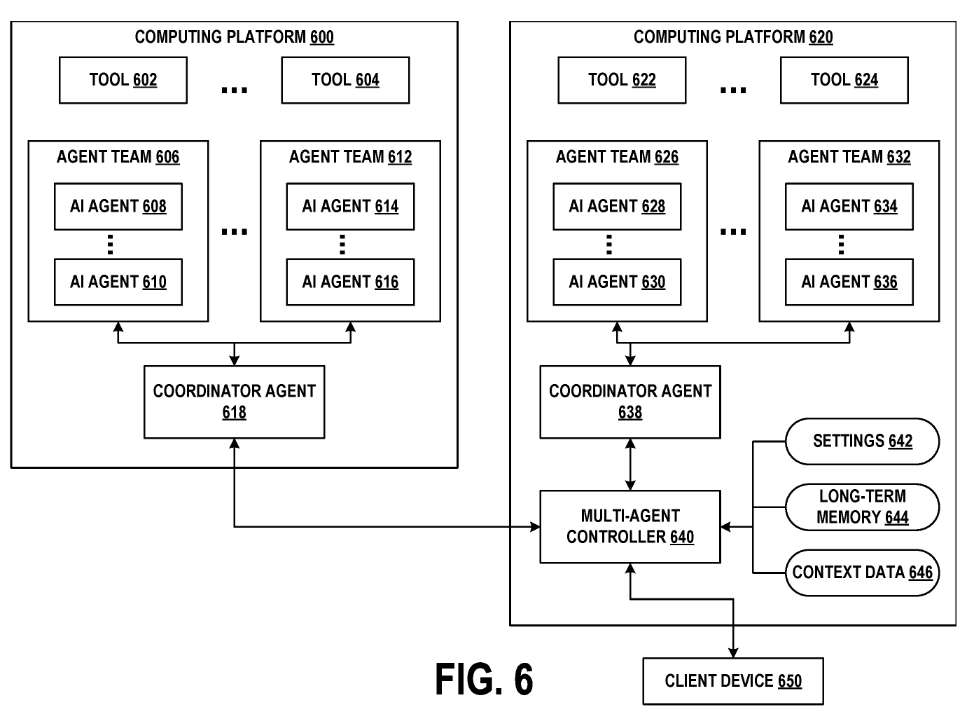

FIG. 6 illustrates an example computing system that includes computing platform 600 and computing platform 620. Each of computing platforms 600 and 620 may include (i) a corresponding plurality of AI agents, which may be organized into one or more AI agent teams, (ii) a corresponding coordinator agent configured to control at least some operations of the corresponding plurality of AI agents, and (iii) corresponding one or more software tools (“tools” for short) usable by the corresponding plurality of AI agents to perform predefined tasks. These components of computing platforms 600 and 620 may be used to address/resolve input queries, including user queries provided by users associated with these platforms.

Specifically, computing platform 600 may include AI agent 608 through AI agent 610 (“AI agents 608-610”), which may form AI agent team 606, and AI agent 614 through AI agent 616 (“AI agents 614-616”), which may form AI agent team 612. AI agents 608-610 and AI agents 614-616 may be collectively referred to as AI agents 608-616. AI agents 608-616 may include and/or be based on large language models (LLMs). Computing platform 600 may also include coordinator agent 618, which may be configured to organize and/or control at least some operations of AI agents 608-616. Computing platform 600 may further include tools 602 through 604 (“tools 602-604”), which may be usable by AI agents 608-616.

Computing platform 620 may include AI agent 628 through AI agent 630 (“AI agents 628-630”), which may form AI agent team 626, and AI agent 634 through AI agent 636 (“AI agents 634-636”), which may form AI agent team 632. AI agents 628-630 and AI agents 634-636 may be collectively referred to as AI agents 628-636. AI agents 628-636 may include and/or be based on LLMs. Computing platform 620 may also include coordinator agent 638, which may be configured to organize and/or control at least some operations of AI agents 628-636. Computing platform 600 may further include tools 622 through 624 (“tools 622-624”), which may be usable by AI agents 628-636.

An AI agent team may include a plurality of AI agents configured to perform similar tasks and/or perform different aspects of a same task. Thus, the plurality of AI agents of the AI agent team may be configured to cooperate with one another to accomplish a task associated with the AI agent team. Different AI agent teams may be configured to perform different types of tasks, with each AI agent team configured to perform a corresponding type of tax associated with the corresponding computing platform. For example, AI agent team 606 may be configured to manage alerts and notifications received by a user (e.g., in connection with computing platform 600 and/or a software application provided thereby), and AI agent team 612 may be configured to analyze the health and/or state of a service or application. In some cases, a given AI agent can belong to multiple agent teams. The AI agents of a given computing platform may be configured to automatically address (e.g., from start to finish) at least some technical issues arising in connection with the given computing platform.

In some implementations, an AI agent team may be organized around task-specialization. That is, each AI agent of the AI agent team may be configured to perform a corresponding function as part of a larger task. For example, in a document processing pipeline, a first AI agent may be configured to retrieve relevant documents, a second AI gent may be configured to extract information from the relevant documents, and a third AI agent may be configured to summarize the information extracted from the relevant documents. Each AI agent may be configured to focus on a discrete part of the overall workflow and may operate largely independently within its assigned role/function.

In some implementations, an AI agent team may be organized as a collaborative dialogue team. The AI agents of a collaborative dialogue team may be configured to engage in structured conversations (e.g., Socratic discussions) to, for example, challenge assumptions, generate alternative perspectives, and/or iteratively improve plans or decisions. Instead of operating independently, the AI agents of a collaborative dialogue team may be configured to co-construct outputs through dialogue and/or debate.

In some implementations, an AI agent team may be organized as a strategy-diverse ensemble. In a strategy-diverse ensemble, all AI agents of the ensemble may share the same overall task, but may be configured to deliberately pursue solving this task through different approaches and/or strategies. Thus, in a strategy-diverse ensemble, diversity of perspective, rather than division of task, may be used as the organizing principle.

A coordinator agent may be configured to generate a plan for using the AI agents, AI agent teams, and/or tools available thereto to perform tasks involved in addressing an input query. Generating the plan may involve reviewing and/or routing the output of AI agents, prioritizing and/or orchestrating AI agents, maintaining coherence of interactions among AI agents, enforcing quality standards, and/or dynamically allocating resources within an agent team or computing platform. In some implementations, the coordinator agent might not itself perform any domain-specific tasks. For example, coordinator agent 618 may be configured to generate a plan for using AI agents 608-616 for performing a task assigned to coordinator agent 618 (e.g., by multi-agent controller 640). In some cases, coordinator agent 618 may be configured to assign a specific task to a particular AI agent of a given AI agent team (e.g., assign the specific task to AI agent 608). In other cases, coordinator agent 618 may be configured to assign a general task to the given AI agent team, thus allowing the AI agents of the given AI agent team to decide how to divide the general task into sub-tasks executable by AI agents 608-610. Coordinator agent 618 may also be configured to track progress in executing the plan, replan, and/or recover from errors arising while addressing the input query. Coordinator agent 638 may be configured to operate in a similar manner with respect to AI agents 628-636.

Some AI agents may be configured to use software tools. A software tool may represent one or more predefined instructions that are configured to perform a corresponding task. The software tool may include, for example, a software function (e.g., operating system shell function), an API call, a plug-in, a workflow, and/or any other grouping of predefined software instructions. Software tools may differ from AI agents in that the software tools might or might not include and/or be based on LLMs or other machine learning models, and may instead specify rule-based operations. For example, each of AI agents 608-616 may be configured to invoke execution of each of tools 602-604, thereby allowing AI agents 608-616 to automatically modify aspects of computing platform 600. Each of AI agents 628-636 may be configured to invoke execution of each of tools 622-624, thereby allowing AI agents 628-636 to automatically modify aspects of computing platform 620.

In some cases, computing platforms 600 and 620 may be physically and/or logically separated from one another. As one example, computing platforms 600 and 620 may be hosted by the same computing system, but may be logically and/or virtually separated from one another (e.g., may be hosted by different computational instances). As another example, computing platforms 600 and 620 may be hosted by different computing systems, and may thus be considered to form part of two different (physically separate) computer networks. For example, computing platform 620 may be hosted by remote network management platform 320, and computing platform 600 may be hosted by managed network 300 and/or public cloud networks 340.

Due at least in part to such physical and/or logical separation of computing platforms 600 and 620, AI agents 608-616 and coordinator agent 618 of computing platform 600 might not (absent utilization of the techniques described herein) be configured to cooperate and/or coordinate with AI agents 628-636 and coordinator agent 638 of computing platform 620. For example, AI agents 608-616 and coordinator agent 618 may be aware of one another, but might not be aware of, and thus might not be able to use, AI agents 628-636, since coordinator agents 618 and 638 might lack a mechanism for communicating with one another. Similarly, AI agents 628-636 and coordinator agent 638 may be aware of one another, but might not be aware of, and thus might not be able to use, AI agents 608-616. Accordingly, absent cross-platform coordination of AI agents, user queries that involve cooperation among one or more of AI agents 608-616 and one or more of AI agents 628-636 might not be addressable and/or resolvable using AI agents 608-616 and 628-636. For example, resolution of a user query regarding a technical issue with a software application that relies on computing resources of both computing platforms 600 and 620 might involve the user submitting multiple separate user queries, with at least a first query submitted to coordinator agent 618 and at least a second query submitted to coordinator agent 638 (possibly based on a response provided by coordinator agent 618).

Further, even when AI agents 608-616, AI agents 628-636, and/or coordinator agents 618 and 638 are communicatively connected, these agentic resources may use different data formats and/or terminology, thus making cooperation, collaboration, and/or mutual understanding more difficult, resulting in poor performance. Yet further, absent the multi-agent controller 640, the plans generated by coordinator agents 618 and 638 may conflict with one another and/or may omit utilization of AI agents that are well-suited and/or best-suited for performing certain tasks.

Accordingly, multi-agent controller 640 may be provided as part of at least one computing platform to allow the AI agents of different computing platforms to cooperate with one another. For example, multi-agent controller 640 may be provided as part of computing platform 620 and may be configured to communicate with coordinator agent 638 and coordinator agent 618. Before receiving and processing input queries, multi-agent controller 640 may be configured to execute a discovery process that allows multi-agent controller 640 to identify (i) attributes of AI agents 628-636, coordinator agent 638, and tools 622-624 available on computing platform 620 and (ii) attributes of AI agents 608-616, coordinator agent 618, and tools 602-604 available on computing platform 600. Thus, multi-agent controller 640 may develop a representation of the agentic resources that are available across multiple different computing platforms.

When multi-agent controller 640 receives an input query from, for example, client device 650, multi-agent controller 640 may be configured to use this representation of the agentic resources to route communications among the agentic resources of computing platforms 600 and 620 to address the input query. As one example, the input query may be a user query provided by a user of client device 650. As another example, the input query may be generated automatically based on and/or in response to an incident and/or an alert generated by and/or associated with client device 650, among other possibilities. Thus, the input query may or might not be associated with a corresponding user. For example, the operations discussed herein may be used to automatically resolve and/or address an incident without user involvement.

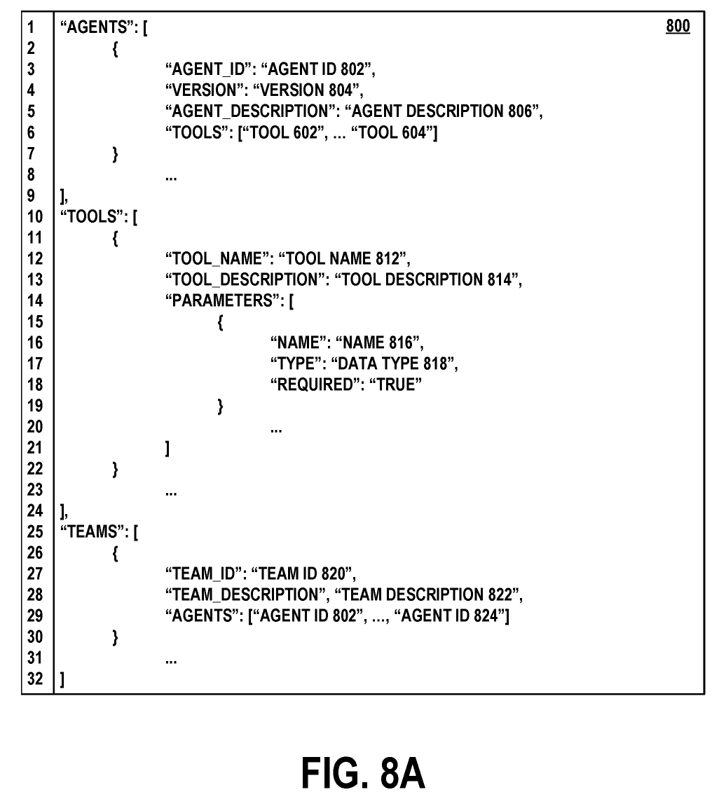

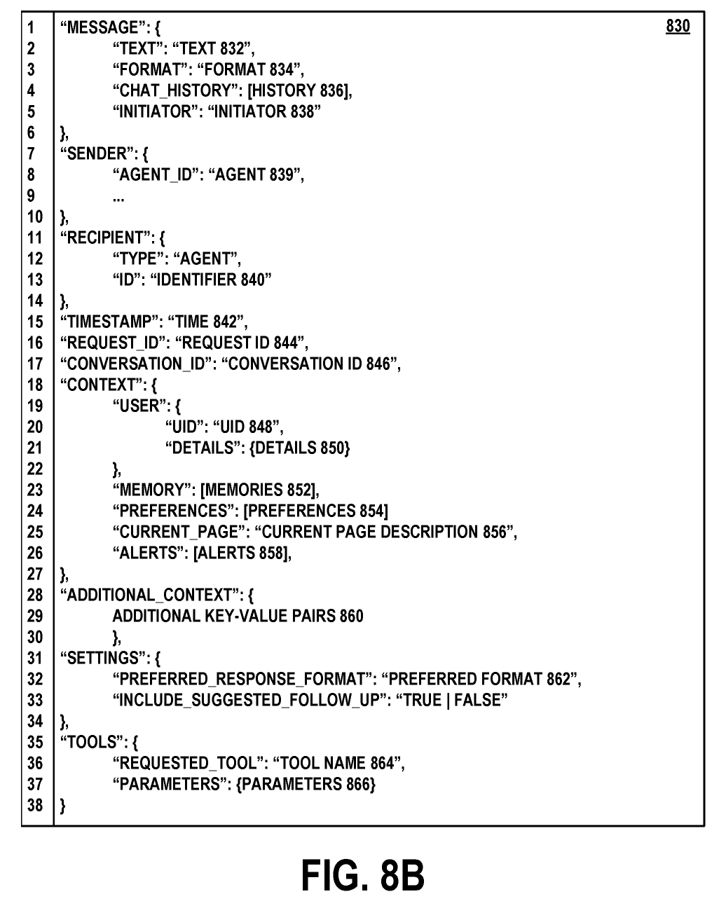

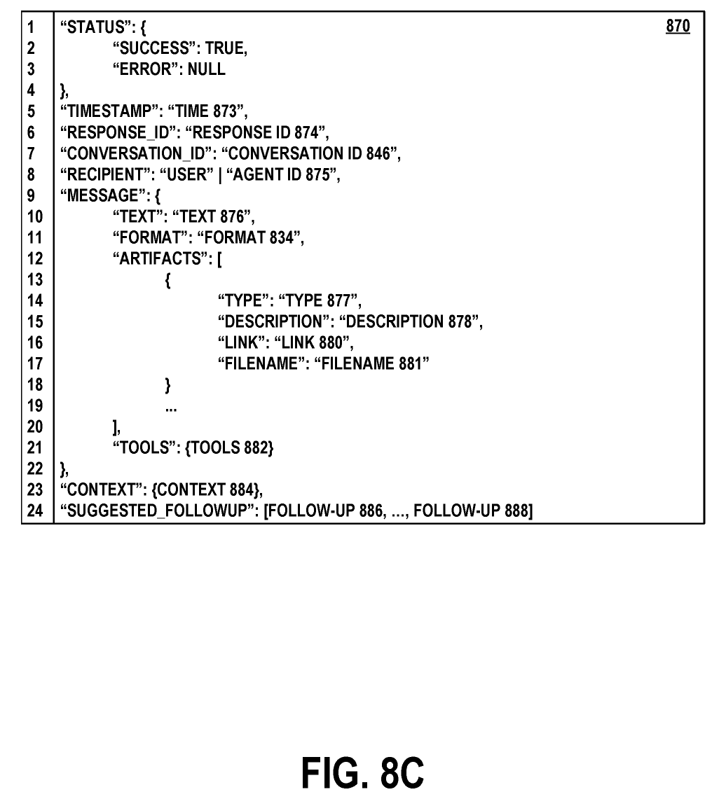

Interoperability of agentic resources across multiple different computing platforms may be facilitated by using a standardized data serialization format (alternatively referred to herein as a standardized data format, for short). For example, multi-agent controller 640 may be configured to specify the data serialization format (e.g., JSON, XML, YAML, etc.), including various key-values pairs to be used by the agentic resources, as part of the discovery process and/or as part of the communications routed to the agentic resources. Examples of the key-value pairs exchanged during the discovery process and conversations among the AI agents when addressing input queries are illustrated in FIGS. 8A, 8B and 8C.

Multi-agent controller 640 may have access to settings 642, long-term memory 644, and/or context data 646. Settings 642 may define various aspects of how a given user (e.g., the user of client device 650) prefers to interact with the agentic resources. For example, settings 642 may indicate the permissions granted to the agentic resources by the user, preferred data types for outputs of the agentic resources, and/or whether the agentic resources are to include suggested follow-up actions when generating outputs, among other possibilities. In some cases, settings 642 may include predefined keys for which the user can specify values. In other cases, the user may be able to define both the keys (i.e., types of settings) and values in settings 642.

Long-term memory 644 may include data that is reused across multiple input queries. As one example, multi-agent controller 640 may be configured to store as part of long-term memory 644 the representation of agentic resources that are available across different computing platforms. As another example, long-term memory 644 may include summaries of actions taken in connection with prior input queries of a given user and/or prior input queries of multiple different users.

Context data 646 may include any contextual data that may be useful and/or relevant for addressing an input query. For example, context data 646 may represent attributes of a user that provided the input query, memories of prior interactions among agentic resources as part of the input query, user preferences, aspects of a page being viewed by the user when submitting the input query, alerts associated with the user at the time of submitting the input query, and/or additional inputs provided by the user during processing of the input query, among other possibilities.

### VIII. Example Agent Discovery and Query Resolution

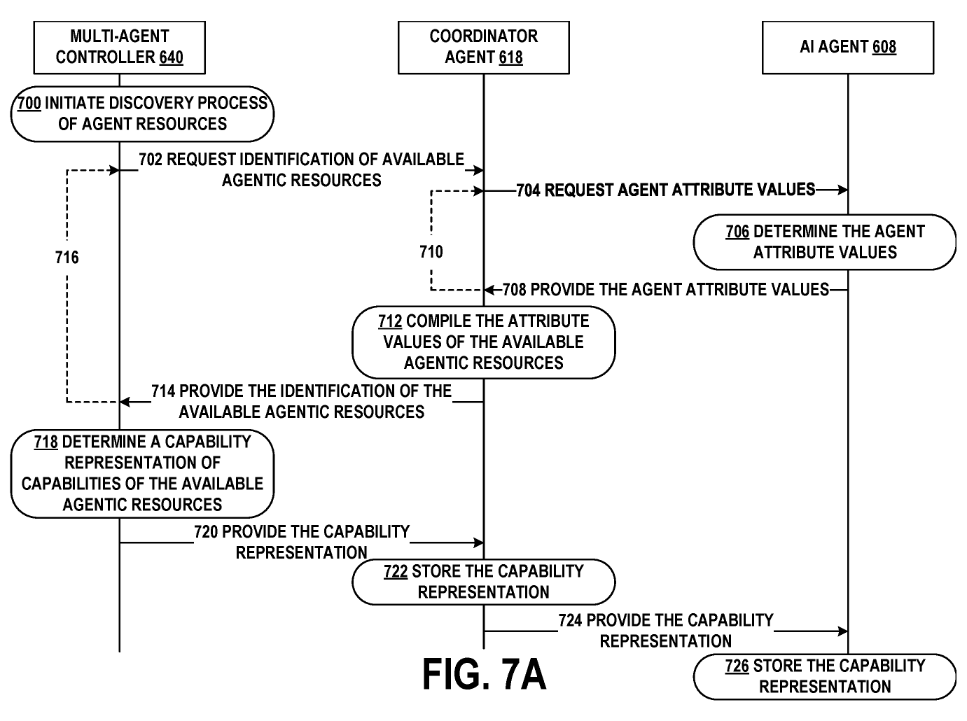

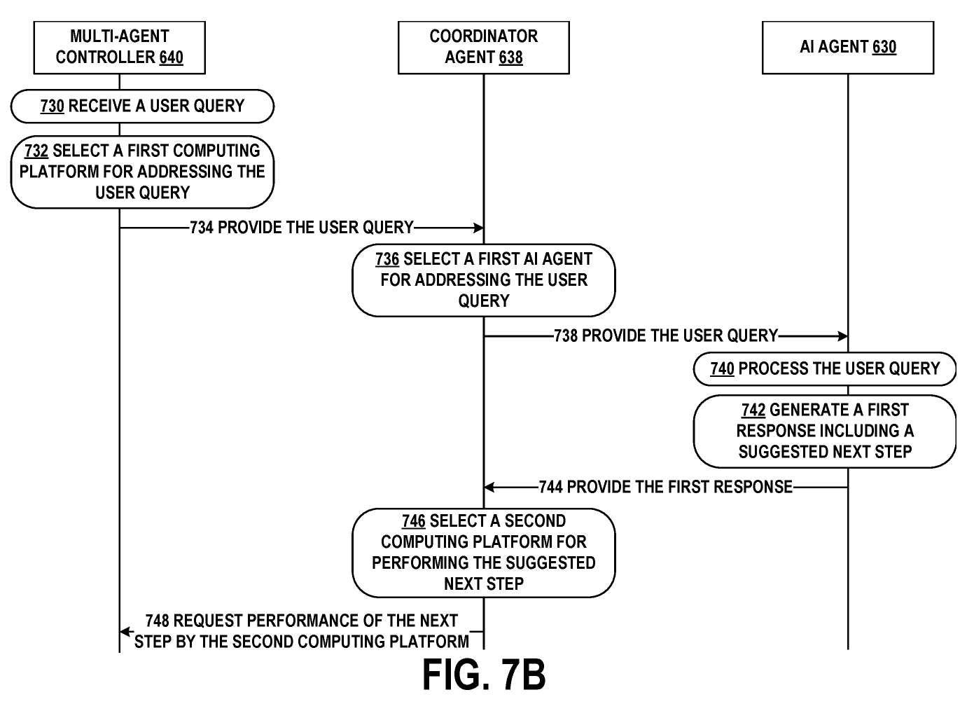

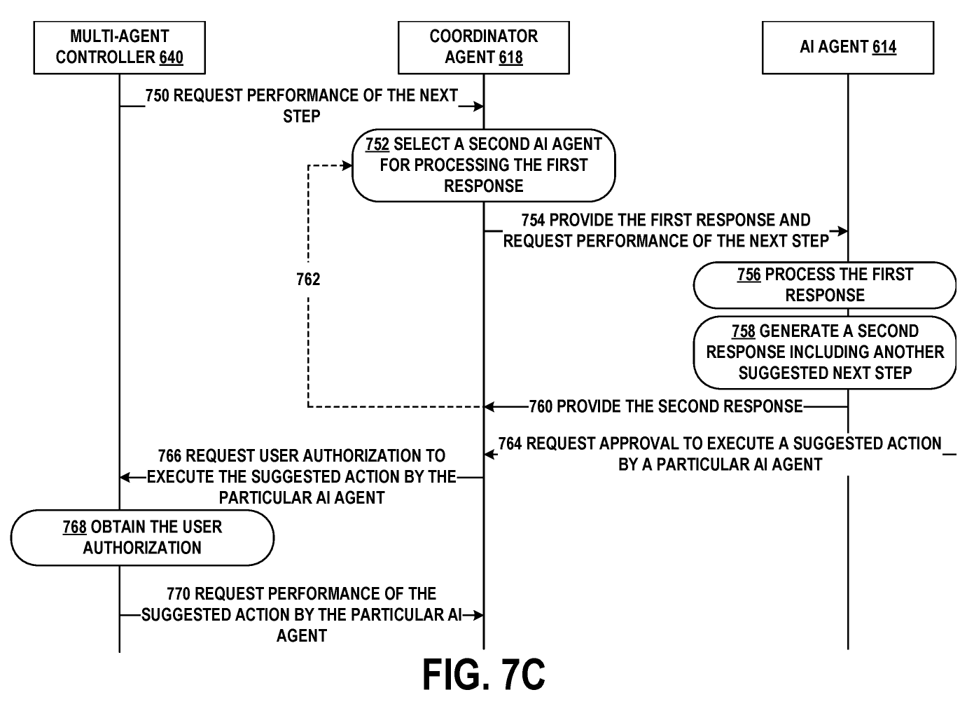

FIG. 7A illustrates a message diagram of example communications exchanged among multi-agent controller 640 and agentic resources of computing platform 600 as part of a discovery process. A similar discovery process may be performed by multi-agent controller 640 in connection with computing platform 620. The discovery process may be configured to allow multi-agent controller 640 to use the agentic resources of computing platform 600 in combination with the agentic resources of computing platform 620 to address input queries. The discovery process executed by multi-agent controller 640 may alternatively be referred to as an agentic discovery process to differentiate it from discovery of non-agentic resources. Multi-agent controller 640 may be configured to initiate the discovery process of agentic resources, as indicated by block 700. For example, the discovery process may be initiated periodically (e.g., once per hour, once per day, once per week, etc.), based on and/or in response to a manual request (e.g., from a user), and/or based on and/or in response to a notification from, for example, coordinator agent 618 that the agentic resources of computing platform 600 have been modified, among other possibilities.

Based on and/or in response to initiation of the discovery process at block 700, multi-agent controller 640 may be configured to transmit, to coordinator agent 618, a request for identification of available agentic resources, as indicated by arrow 702. The request at arrow 702 may include a textual prompt (e.g., “Specify the agentic resources that you coordinate, including the capabilities of each agent.”) and a standardized data format to be used by coordinator agent 618 when providing a response. For example, the request at arrow 702 may specify that coordinator agent 618 is to respond using a format that is the same as or similar to that shown in FIG. 8A. Specifically, the request at arrow 702 may specify, using the standardized data format, the keys for which coordinator agent 618 is to provide values that represent attributes of the available agentic resources.

The request at arrow 702 may be transmitted to, for example, an API and/or a web address that has been set up on computing platform 600 for handling communications from agentic resources in other computing platforms. The API and/or web address may be set up before initiation of the discovery process, and may thus allow multi-agent controller 640 to remotely access the agentic resources of computing platform 600 both as part of the discovery process and input query resolution.

Based on and/or in response to reception of the request at arrow 702, coordinator agent 618 may be configured to transmit, to AI agent 608, a request for attribute values associated with AI agent 608, as indicated by arrow 704. The request at arrow 704 may include a textual prompt (e.g., “Specify the function you perform, the team to which you belong, and the tools you can use.”) and the standardized format to be used by AI agent 608 when providing a response. For example, the format to be used by AI agent 608 may be based on (e.g., the same as and/or a subset of) the format specified by multi-agent controller 640 at arrow 702.

Based on and/or in response to reception of the request at arrow 704, AI agent 608 may be configured to determine the attribute values of AI agent 608, as indicated by block 706. Based on and/or in response to determination of the agent attribute values at block 706, AI agent 608 may be configured to provide the agent attribute values to coordinator agent 618, as indicated by arrow 708. AI agent 608 may, for example, fill out one or more entries in the agents array, as shown in FIG. 8A, thereby representing its own capabilities using the format specified by multi-agent controller 640.

The operations of arrow 704, block 706, and arrow 708 may be repeated one or more times, as indicated by arrow 710, for additional AI agents coordinated by coordinator agent 618 (e.g., AI agent 610 and AI agents 614-616), AI agent teams (e.g., AI agent teams 606-612), and/or software tools (e.g., software tools 602-604). Alternatively, in some cases, the AI agent teams may be identified to coordinator agent 618 by the AI agents that make up theses teams, and/or the software tools may be identified to coordinator agent 618 by the AI agents that use these tools. Based on and/or in response to coordinator agent obtaining corresponding agent attributes from each of AI agents 608-616, coordinator agent 618 may be configured to compile the attribute values of AI agents 608-616 (i.e., the agentic resources available thereto) into a response organized according to the format specified by multi-agent controller 640 at arrow 702, as indicated by block 712. In some cases, coordinator agent 618 may de-duplicate redundant information received from multiple AI agents (e.g., consolidate multiple reports of a tool into one representation of the tool). The response generated at block 712 may be structured as shown in FIG. 8A, and may include both the keys specified by multi-agent controller 640 and the values specified by coordinator agent 618. Based on and/or in response to generation of the response at block 712, coordinator agent 618 may be configured to provide the response to multi-agent controller 640, thereby identifying the available agentic resources and the capabilities thereof, as indicated by arrow 714.The operations of block 700 through arrow 714 may be repeated one or more times with respect to corresponding coordinator agents and agentic resources of other computing platforms. As one example, the operation of block 700 through arrow 714 may be executed with respect to computing platform 620, thereby allowing multi-agent controller 640 to determine the agentic resources available on computing platform 620 and the capabilities thereof. As another example, the operation of block 700 through arrow 714 may be executed with respect to another computing platform (i.e., other than 600 and 620), thereby allowing multi-agent controller 640 to determine the agentic resources available on this other computing platform and the capabilities thereof.

Based on and/or in response to reception of representations of the agentic resources available across different computing platforms, as indicated by arrow 714, multi-agent controller 640 may be configured to determine a capability representation of capabilities of the agentic resources available across the different computing platforms, as indicated by block 718. For example, the capability representation of available agentic resources determined at block 718 may represent all the agentic resources, including attributes thereof, that are available for responding to user queries obtained through multi-agent controller 640. The representation of available agentic resources may be structured according to the standardized data format, thus facilitating interpretation thereof by the available agentic resources.

In some cases, the response generated at block 712 may include a corresponding value for each key specified by multi-agent controller 640 at arrow 702. That is, the response at block 712 may be complete in that it may include all of the information requested by multi-agent controller 640. In other cases, the response generated at block 712 may include a corresponding value for some, but not all, keys specified by multi-agent controller 640 at arrow 702. That is, the response at block 712 may be incomplete in that it may include some, but not all, of the information requested by multi-agent controller 640. Multi-agent controller 640 may be configured to utilize both complete and incomplete responses from coordinators agents for determining the capability representation at block 718. Specifically, since multi-agent controller 640 may be based on and/or include an LLM, multi-agent controller 640 might benefit from, but might not necessitate, each response including all of the requested information. That is, multi-agent controller 640 may be able to tolerate missing information, and this missing information might not prevent multi-agent controller from continuing the discovery process and/or subsequently addressing input queries. Coordinator agents and/or AI agents may exhibit a similar tolerance to missing information when addressing input queries.

Based on and/or in response to determination of the capability representation at block 718, multi-agent controller 640 may be configured to provide the capability representation to coordinator agent 618, as indicated by arrow 720, thereby informing coordinator agent of the agentic resources (and the capabilities thereof) available in computing platform 620. Based on and/or in response to reception of the capability representation by multi-agent controller 640, multi-agent controller 640 may be configured to store the capability representation (e.g., in long-term memory thereof), as indicated by block 722. Storing the capability representation may allow multi-agent controller 640 to use the representation later when selecting and coordinating agentic resources to address an input query. Multi-agent controller 640 may also be configured to provide the capability representation to other coordinator agents of other computing platforms, including coordinator agent 638, thereby informing the other coordinator agents of the agentic resources available thereto across multiple different computing platforms.

Based on and/or in response to reception of the capability representation by multi-agent controller 640 at arrow 720 and/or storage thereof at block 722, multi-agent controller 640 may also be configured to share at least part of this representation with AI agent 608, as indicated by arrow 724. Based on and/or in response to reception of this representation by AI agent 608, AI agent 608 may be configured to store this representation (e.g., in long-term memory thereof), as indicated by block 726. Storing the capability representation may allow AI agent 608 to use the representation later when addressing part of the input query to, for example, suggest subsequent steps to be performed by other AI agents to address the input query.

The operations of FIG. 7A provide an improvement over using existing APIs, which are often declarative, versioned, and/or relatively static. Specifically, since the interactions among multi-agent controller 640, coordinator agent 618, and/or AI agent 608 are based on natural language prompts and the standardized data format (which is specified as part of the prompts), the interactions may be largely unaffected by changes in multi-agent controller 640, coordinator agents, AI agents, and/or the standardized data format. That is, modifications to a (static) API (e.g., an addition of a new input expected by a function) might cause some software components to be unable to use this API without an update that adapts the software components to the API as modified (e.g., new software code that provides the new input to the function). On the other hand, changes to components of computing platforms 600 and/or 620 may be implicitly accounted for by using natural language prompts and responses, which may be automatically used to adapt to, handle, and/or account for any such changes.

As one example, when the request at arrow 702 and/or the request at arrow 704 specifies a new version of the standardized data format, coordinator agent 618 and/or AI agent 608 may simply use the new version of the standardized data format when generating a response, without any modifications, code updates, and/or retraining of coordinator agent 618 and/or AI agent 608. As another example, a new AI agent added to computing platform 600 may be discovered and used by multi-agent controller 640 automatically and/or without dependence on new software code that utilizes the new AI agent. As a further example, a deletion of an existing AI agent may be discovered by multi-agent controller 640, and the absence of this AI agent from the updated representation as generated at block 718 may preclude further usage of this AI agent by components of platforms 600 and 620 (again, without dependence on modifications to any software code that previously utilized this AI agent). As a yet further example, information that is requested using the standardized data format (e.g., represented using a key therein) but unavailable to, for example, an AI agent generating a response may simply be omitted from the response (e.g., a value might not be specified for the key). Other agentic resources may nevertheless be able to operate despite the response being incomplete (e.g., by assuming the information to be missing and/or unavailable), rather than, for example, generating an error and ceasing further operations as would some existing APIs.

FIGS. 7B and 7C illustrate operations related to addressing an input query using multi-agent controller 640 and the agentic resources available thereto across multiple different computing platforms. Multi-agent controller 640 may be configured to receive, for example, a user query, as indicated by block 730. In some implementations, the user query may be received at block 730 after multi-agent controller 640 has completed the discovery process illustrated in FIG. 7A. In other implementations, reception of the user query at block 730 may cause multi-agent controller 640 to initiate the discovery process (e.g., to discover the available agentic resources for the first time) and/or repeat the discovery process (e.g., to update a previously generated representation of the available agentic resources).

Based on and/or in response to reception of the user query at block 730, multi-agent controller 640 may be configured to select a first computing platform for addressing the user query. As one example, multi-agent controller 640 may be configured to use the capability representation determined at block 718 and the user query (and possibly also a predefined textual prompt that defines the task to be performed by multi-agent controller 640) to identify a computing platform that is most likely to be able to use the agentic resources thereof to at least start addressing the user query. As another example, multi-agent controller 640 may be configured to route the user query to a default computing platform, such as computing platform 620 in which multi-agent controller 640 is disposed. In the illustrated example, computing platform 620 is used as an example of the first computing platform. Accordingly, based on and/or in response to selection of computing platform 620, multi-agent controller 640 may be configured to provide the user query to coordinator agent 638 of computing platform 620 (e.g., using an API and/or web address provided by computing platform 620), as indicated by arrow 734.

Based on and/or in response to reception of the user query at arrow 734, coordinator agent 638 may be configured to select a first AI agent for addressing the user query, as indicated by block 736. For example, coordinator agent 638 may be configured to use the capability representation determined at block 718 and the user query (and possibly also a predefined textual prompt that defines the task to be performed by coordinator agent 638) to determine that AI agent 630 is capable of performing a first step in addressing the user query. In some cases, selection of AI agent 630 may be part of a multi-step plan developed by coordinator agent 638 for addressing the user query.

Based on and/or in response to selection of AI agent 630 at block 736, coordinator agent 638 may be configured to provide the user query to AI agent 630, as indicated by arrow 738. Based on and/or in response to reception of the user query at arrow 738, AI agent 630 may be configured to process the user query (and possibly also a predefined textual prompt that defines the task to be performed by AI agent 630), as indicated by block 740. Based on and/or in response to processing the user query at block 740, AI agent 630 may be configured to generate a first response, as indicated by block 742. The first response may include a partial resolution (e.g., completion of an intermediate step in reaching a complete resolution) of the user query, and may include a suggested next step to be taken by one or more agentic resources in addressing the user query.

Based on and/or in response to generation of the first response at block 742, AI agent 630 may be configured to provide the first response to coordinator agent 638, as indicated by arrow 744. In some implementations, the first response generated by AI agent 630 might not include the suggested next step, and the suggested next step may instead be determined by coordinator agent 638.

Based on and/or in response to reception of the first response at arrow 744, coordinator agent 638 may be configured to select a second computing platform for performing the suggested next step, as indicated by block 746. In some implementations, selecting the second computing platform at block 746 may involve selecting a specific AI agent within the second computing platform that coordinator agent 638 determines to be capable of performing the next step. In other implementations, the second computing platform may be selected at block 746 without selection of any particular AI agent within the second computing platform for performing the next step, thereby allowing the coordinator agent of the second computing platform to perform selection of the particular AI agent. Selection of the second computing platform at block 746 may include coordinator agent 638 verifying that (i) the suggested next step is consistent with a resolution plan developed (e.g., at block 736) by coordinator agent 638 for the user query, (ii) modifying the suggested next step, and/or (iii) replacing the suggested next step.

Based on and/or in response to selection of the second computing platform at block 746, coordinator agent 638 may be configured to provide, to multi-agent controller 640, a request for performance of the next step by the second computing platform, as indicated by arrow 748. In some implementations, the second computing platform may be selected and/or selection thereof may be confirmed by multi-agent controller 640. In the example illustrated in FIGS. 7B and 7C, computing platform 600 represents the second computing platform. Turning to FIG. 7C, based on and/or in response to reception of the request at arrow 748, multi-agent controller 640 may be configured to provide, to coordinator agent 618 of computing platform 600 (e.g., using the API and/or web address exposed thereby), a request for performance of the next step (e.g., as originally suggested by AI agent 630, and/or as modified by coordinator agent 638), as indicated by arrow 750.

Based on and/or in response to reception of the request at arrow 750, coordinator agent 618 may be configured to select a second AI agent for processing the first response generated by AI agent 630, as indicated by block 752. For example, coordinator agent 618 may be configured to use the capability representation determined at block 718 and the first response (and possibly also a textual prompt that defines the task to be performed by coordinator agent 618) to determine that AI agent 614 is capable of performing a second step in addressing the user query.

Based on and/or in response to selection of AI agent 614 at block 752, coordinator agent 618 may be configured to provide, to AI agent 614, the first response and request performance of the next step thereby, as indicated by arrow 754. Based on and/or in response to reception of the first response and request at arrow 754, AI agent 614 may be configured to process the first response, as indicated by block 756. Based on and/or in response to AI agent 614 processing the first response at block 756, AI agent 614 may be configured to generate a second response, as indicated by block 758. The second response may include a further partial resolution (e.g., completion of another intermediate step in reaching a complete resolution) of the user query, and may include another suggested next step to be taken by one or more agentic resources in addressing the user query. That is, AI agents 630 and 614 may cooperatively operate in sequence, with AI agent 614 utilizing the output of AI agent 630 in bringing the user query closer to a resolution.

Based on and/or in response to generation of the second response at block 758, AI agent 614 may be configured to provide the second response to coordinator agent 618, as indicated by arrow 760. In some cases, the operations of block 752 through arrow 760 and/or the operations of block 746 through arrow 750 may be repeated one or more times to execute the next step suggested at block 758 using one or more agentic resources in computing platform 600, computing platform 620, and/or another computing platform discovered by multi-agent controller 640.

In some implementations, a particular AI agent that performs one of the steps involved in addressing the user query may be configured to provide, to coordinator agent 618, a request for approval to execute a suggested action, as indicated by arrow 764. Based on and/or in response to reception of the request at arrow 764, coordinator agent 618 may be configured to provide, to multi-agent controller 640, a request for user authorization to execute the suggested action by the particular AI agent, as indicated by arrow 766. For example, coordinator agent 618 may determine that settings 642 indicate that the user prefers that the suggested action is presented to the user for approval before execution thereof (e.g., rather than approved by coordinator agent 618 and/or multi-agent controller 640).

Based on and/or in response to reception of the request at arrow 766, multi-agent controller 640 may be configured to obtain the user authorization, as indicated by block 768. For example, multi-agent controller 640 may provide client device 650 with a prompt requesting the user authorization, and the user authorization may be provided by the user by way of a user interface of client device 650. In some cases, the prompt for user authorization may include at least part of the history of actions of and interactions among the agentic resources that occurred in reaching the suggested action. Thus, the prompt may allow the user to inspect how the agentic resources arrived at the decision to perform the suggested action, thereby better informing the user’s decision about whether to provide user authorization for the suggested action.

Based on and/or in response to obtaining the user authorization at block 768, multi-agent controller 640 may be configured to provide, to coordinator agent 618, a request for performance of the suggested action by the particular AI agent, as indicated by arrow 770. In some cases, performance of the suggested action by the particular AI agent may represent, cause, and/or implement a resolution of the user query.

### IX. Example Communication Formats

FIG. 8A illustrates an example response 800 that may be received by multi-agent controller 640 from a coordinator agent as part of the discovery process to collect information about the agentic resources available from multiple different computing platforms. Specifically, response 800 may form part of the communication provided to multi-agent controller 640 by the coordinator agent to identify the agentic resources available to the coordinator agent in a given computing platform. In response 800, the agents array as shown on lines 1-9 may represent one or more AI agents available from the given computing platform, the tools array as shown on lines 10-24 may represent one or more tools available on the given computing platform to the one or more AI agents, and the teams array as shown on lines 25-32 may represent one or more teams into which the one or more AI agents are organized.

As an example, response 800 may be provided to multi-agent controller 640 by coordinator agent 618. Thus, the agents array on lines 1-9 may represent AI agents 608-616, the tools array on lines 10-24 may represent tools 602-604, and the teams array on lines 25-32 may represent agent teams 606-612. Specifically, lines 3-6 may indicate, respectively, that AI agent 608 (i) is assigned an agent identifier of agent ID 802, (ii) is currently in version 804, (iii) is configured to perform operations summarized by agent description 806, and (iv) is configured to use tools 602-604. Similar information may be specified for other AI agents, as indicated by the ellipsis on line 8. Some portions of response 800 may be specified by AI agents 608-616, with coordinator agent 618 combining these portions into a complete response. For example, each respective AI agent of AI agents 608-616 may provide data about its own capabilities, teams, and/or tools, thereby specifying its corresponding portions of the agents, tools, and teams arrays.

Lines 12-14 may indicate, respectively, that tool 602 (i) is assigned tool name 812, (ii) is configured to perform operations summarized by tool description 814, and (iii) is configured to process the parameters represented by lines 14-19. Specifically, as indicated by lines 16-18, the parameters include a required parameter having parameter name 816 and data type 818. Tool 602 may also be configured to process other parameters, as indicated by the ellipsis on line 20. Similar information may be specified for other tools, as indicated by the ellipsis on line 23.

Lines 27-29 may indicate, respectively, that agent team 606 (i) is assigned team ID 820, (ii) is configured to perform operations summarized by team description 822, and (iii) includes AI agent 608 (associated with agent ID 802) through AI agent 610 (associated with agent ID 824). Similar information may be specified for other agent teams, as indicated by the ellipsis on line 31.

FIG. 8B illustrates an example request 830 that may be provided by, for example, multi-agent controller 640 to a coordinator agent and/or by the coordinator agent to one or more AI agents. Request 830 provides an example of the standardized data format that may be used when prompting agentic resources to operate to address aspects of the input query. Request 830 includes a message object on lines 1-6, a sender object on lines 7-10, a recipient object on lines 11-14, a timestamp on line 15, a request identifier on line 16, a conversation identifier on line 17, a context object on lines 18-27, an additional context object on line 28-30, a settings object on lines 31-34, and a tools object on lines 35-38.

The message object on lines 1-6 includes text 832 structured according to format 834 (e.g., markdown, HTML, etc.). Text 832 represents the query to be processed and/or addressed by the recipient of request 830. Initiator 838 represents an entity that provided the input query to be addressed by the agentic resources of multiple different computing platforms. For example, initiator 838 may indicate that the initial query was provided by a user, by a software application, and/or by an agentic resource. The message object also includes a chat history array having value(s) of history 836 that represent aspects of and/or an entirety of prior interactions among AI agents in connection with the input query to which request 830 corresponds. That is, history 836 may represent and/or summarize actions that have been taken thus far in connection with the input query and/or with prior input queries related thereto, and my thus inform actions to be taken by the recipient of request 830.

The sender object on lines 7-10 may include an agent identifier that represents the agentic resource that generated request 830. In the example, of FIG. 8B, the agent identifier is assigned a value of agent 839, which represents coordinator agent 618 of FIG. 6. The agent identifier of line 8 may alternatively represent multi-agent controller 640 or another coordinator agent. The sender object on lines 7-10 may be structured similarly to entries of the agents array on lines 1-9 of FIG. 8A, and the remainder thereof is thus indicated with an ellipsis.

The recipient object on lines 11-14 may include a type identifier that indicates whether request 830 is addressed to an AI agent (i.e., a value of “agent,” as shown) or a team of AI agents (i.e., a value of “team,” not shown). The recipient object may also include an identifier field that includes an identifier of the agentic resource to which request 830 is addressed. For example, when request 830 is addressed to an AI agent, the identifier field may include an agent identifier thereof, and when request 830 is addressed to a team of AI agents, identifier field may include a team identifier thereof. In the example shown, the identifier field is assigned a value of identifier 840, which may represent AI agent 614.

The timestamp on line 15 may indicate that request 830 has been generated at time 842. The request identifier on line 16 may indicate that request 830 is uniquely identified by request ID 844, thus allowing request 830 to be disambiguated from other requests. The conversation identifier on line 17 may indicate that request 830 is part of a conversation having conversation ID 846. Each conversation may be associated with a corresponding input query, and may include a plurality of requests and responses. Thus, conversation ID 846 may differentiate the conversation of which request 830 forms part from other conversation, and may allow requests and responses related to the same conversation to be linked together.

The context object on lines 18-27 may include a user object on lines 19-22, a memory array on line 23, a preferences array on line 24, a current page descriptor on line 25, and an alerts array on line 26. The context object may provide the recipient AI agent or AI agent team with data (e.g., summaries of prior outputs generated in connection with the input query) that may be relevant in assessing and resolving the input query or portion thereof. The user object on lines 19-22 may represent various attributes of a user that initiated and/or is associated with the conversation (having conversation ID 846) of which request 830 is part. For example, these attributes may include user ID 848 and details 850 about the user. Details 850 may include, for example, a role assigned to the user within an organization and/or a language spoken/understood by the user, among others.

The memory array on line 23 may include memories 852, which may include summaries of prior messages exchanged among agentic resources in connection with the current conversation (e.g., short-term memories) and/or prior conversations (e.g., long-term memories) associated with the user. In some cases, rather than including summaries, the entirety of some prior messages may be included in memories 852. The preferences array on line 24 may include preferences 854, which may include one or more preferences specified by the user for using agentic resources. Preferences 854 may indicate, for example, a preferred length of responses from AI agents, whether the user wants AI agents to ask for permission to execute certain types of tasks, the data types that the user prefers in responses from the AI agents (e.g., text, images, graphs, etc.), and/or whether the user prefers to see intermediate outputs generated by the AI agents in arriving at the final output, among others.

The current page descriptor on line 25 may include current page description 856, which may represent the contents of the page (e.g., webpage, screen of an app, etc.) that the user was viewing when submitting the input query. Current page description 856 may include a textual description of the page, a graphical representation of the page, and/or a vector embedding of the page, among others.

The alerts array on line 26 may include alerts 858, which may represent attributes of one or more alerts that were associated with the user when the input query was submitted. For each respective alert of alerts 858, the alerts array may include a textual description of the respective alert, a timestamp of the respective alert, a status of the alert, a severity of the respective alert, and/or one or more configuration items (e.g., hostname and IP address) associated with the respective alert.

The additional context object on lines 28-30 may include additional key-value pairs 860, which may include information that might not otherwise fit into the predetermined fields of the context object on lines 18-27. That is, the additional context object may provide the sender with a place to include information that is likely to be relevant in addressing the input query but that does not correspond to any of the fields of the context object. Thus, the additional context object may allow AI agents the flexibility to include new types of information and/or query-specific information in request 830.

The settings object on lines 31-34 may indicate that the user and/or sender prefers that the recipient uses preferred format 862 when responding to request 830. Preferred format 862 may specify a preferred data type of the response and/or a preferred format of, for example, the text contained in the response (e.g., markdown, HTML, JSON, etc.). Line 33 of the settings object may indicate whether the recipient is requested to include a suggested follow-up action to execute next. For example, when the value on line 33 is TRUE, the recipient may include a suggested next step, and when the value on line 33 is “FALSE,” the recipient may omit the suggested next step and may instead allow the coordinator agent to plant the next step.

The tools object on line 35-38 may indicate that the recipient is requested and/or permitted to execute a tool having tool name 864 using parameters 866. The parameters object on line 37 may be similar in structure to the parameters object on lines 14-20 of FIG. 8A, albeit with different values.

FIG. 8C illustrates an example response 870 that may be provided by a coordinator agent to multi-agent controller 640 and/or by an AI agent to the coordinator agent. Response 870 provides an example of the standardized data format that may be used by agentic resources when responding to requests to address aspects of the input query. For example, response 870 may be generated based on and/or in response to request 830. Response 870 includes a status object on lines 1-4, a timestamp on line 5, a response identifier on line 6, a conversation identifier on line 7, a recipient identifier on line 8, a message object on lines 9-22, context object on line 23, and a suggested follow-up array on line 24.

Line 2 of the status object on line 1-4 may indicate whether the operation requested by request 830 succeeded (i.e., “TRUE,” as shown) or failed (“FALSE”). If this operation failed, line 3 may specify an error generated in connection with the failure (none in the example shown). The timestamp on line 5 may indicate that response 870 has been generated at time 873. The response identifier on line 6 may indicate that response 870 is uniquely identified by response ID 874, thus allowing response 870 to be disambiguated from other responses. The conversation identifier on line 7 may indicate that response 870 is part of the conversation having conversation ID 846 (i.e., the same conversation as request 830).

The message object on lines 9-22 includes text 876 structured according to format 834. Text 832 may represent an intermediate solution to the input query as generated by the AI agent (represented by agent identifier 840) based on request 830. The message object may also include an artifacts array on lines 12-20, which may include any non-textual data (e.g., images, videos, graphs, webpages, etc.) generated by the AI agent based on request 830. For each respective artifact in the artifacts array, the artifacts array may indicate a type of the respective artifact (e.g., type 877), a textual description of the content of the respective artifact (e.g., description 878), a link to the respective artifact (e.g., link 880), and a filename of the respective artifact (e.g., filename 881).

The tools object on line 21 may indicate that the AI agent is requesting and/or suggesting execution of tools 882 with corresponding parameter values (not shown). The structure of the tools object on line 21 may be similar to the tools object on lines 35-38 of FIG. 8B, albeit with different values. The suggested follow-up array on line 24 may include follow-up 886 through follow-up 888, each of which represents a suggested action to be taken by one or more other AI agents to incrementally reach resolution of the input query. A given follow-up of follow-ups 886-888 may identify an AI agent to be used, identify a software tool to be used, specify a question to be asked of another AI agent, and/or specify information that is needed to further resolve the input query, among other possibilities. In some cases, follow-ups 886-888 may be ranked according to importance and/or likelihood of furthering resolution of the input query.

### X. Example Operations

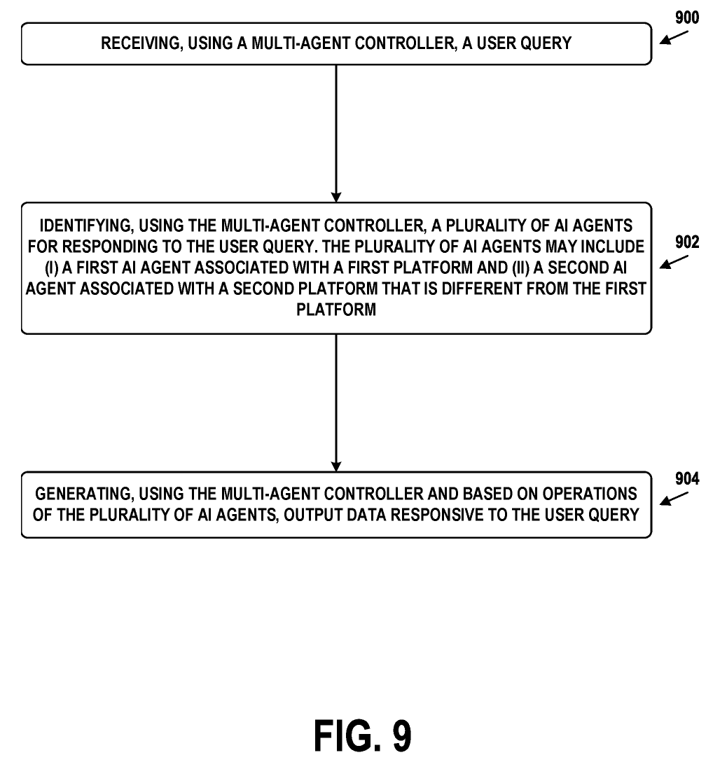

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

Block 900 involves receiving, using a multi-agent controller, a user query.

Block 902 involves identifying, using the multi-agent controller, a plurality of AI agents for responding to the user query. The plurality of AI agents may include (i) a first AI agent associated with a first platform and (ii) a second AI agent associated with a second platform that is different from the first platform.

Thus, the multi-agent controller allows the AI agents of different computing platforms to collaborate and/or cooperate with one another, thereby increasing the amount of agentic resources that are available for automatically addressing the user query and/or data available to these agentic resources. Further, collaboratively using the AI agents of different computing platforms allows user queries to be addressed more quickly and efficiently (i.e., utilizing fewer computing resources, such as processor cycles and memory, and electrical energy) by directing the user query to AI agents that are well-suited and/or best-suited for the type of tasks involved in addressing the user query, rather than using only the AI agents that are available in a single computing platform and that might be poorly-suited for the type of tasks involved in addressing the user query.

As one example, the second AI agent may be configured to perform a task that no other AI agent in the first computing platform is able to perform. As a second example, the second AI agent may have access to data that is present on the second computing platform and that the first AI agent might not be able to directly access. Through collaboration among these AI agents, this data may be shared by the second AI agent with the first AI agent, allowing the first AI agent to operate both on the data available in the first computing platform and the data obtained from the second computing platform via the second AI agent. As a third example, the multi-agent controller (and/or the first AI agent) may have access to context data (e.g., a user’s role, occupation, etc.) and/or memories that would be inaccessible to the second AI agent if the user query were provided directly to the second AI agent. Through collaboration among these AI agents, this context data and/or memories may be shared by the first AI agent with the second AI agent, allowing the second AI agent to consider context available on the first computing platform. Accordingly, in each of these examples, the multi-agent controller may allow for resolution of queries that might not be resolvable using either computing platform alone.

Block 904 involves generating, using the multi-agent controller and based on operations of the plurality of AI agents, output data responsive to the user query.

Some examples may involve routing, using the multi-agent controller and between the plurality of AI agents, one or more communications representing intermediate results generated by the plurality of AI agents in responding to the user query.

In some examples, the one or more communications may include an instruction configured to cause at least one AI agent of the plurality of AI agents to use a software tool available to the at least one AI agent.

In some examples, identifying the plurality of AI agents may include selecting the first AI agent based on the user query. Routing the one or more communications may include: (i) providing a first request to the first AI agent based on the user query and (ii) receiving, from the first AI agent, a first response to the first request and representing a first intermediate result generated by the first AI agent. Identifying the plurality of AI agents may include selecting the second AI agent based on the first response. Routing the one or more communications may include: (i) providing, to the second AI agent, a second request based on the first response and (ii) receiving, from the second AI agent, a second response to the second request and representing a second intermediate result generated by the second AI agent.

In some examples, each of the first request and the second request may specify a data serialization format used by the plurality of AI agents in generating and processing the one or more communications. Each of the first request, the second request, the first response, and the second response may be represented using the data serialization format. Each of the first AI agent and the second AI agent may be configured to process, respectively, the first request and the second request as represented using the data serialization format. Each of the first AI agent and the second AI agent may be configured to generate, respectively, the first response and the second response structured according to the data serialization format.

In some examples, each respective request of the first request and the second request may include one or more key-value pairs specifying attributes of one or more of: a sender AI agent of the respective request, a recipient AI agent of the respective request, a task to be performed by the recipient AI agent, a context data associated with the user query, an input data artifact associated with the user query, a user that provided the user query, or a software tool available to the sender AI agent. Each respective response of the first response and the second response may include one or more further key-value pairs specifying attributes of one or more of: an output of the task as performed by the recipient AI agent based on the respective request, an output data artifact generated by the recipient AI agent, a suggested follow-up task to be performed by one or more AI agents of the plurality of AI agents, or a further software tool requested to be executed on behalf of the recipient AI agent.

Some examples may involve generating, based on the output data, a graphical user interface that indicates a response to the user query.

In some examples, the first platform may be provided by a first computing system. The second platform may be provided by a second computing system. The first computing system may be different from the second computing system.

In some examples, the first platform may include a remote network management platform. The second platform may include a third-party platform disposed outside of the remote network management platform. The plurality of AI agents may be configured to communicate using a common data format specified by the remote network management platform.

In some examples, the plurality of AI agents may be configured to process context data associated with the user query. The multi-agent controller may be configured to provide the context data to the plurality of AI agents. The context data may include one or more of: an attribute of a user that provided the user query, memory data associated with at least one of the user query or a prior user query provided by the user, a user preference specified by the user for executing the plurality of AI agents, a current page viewed by the user, or an alert representing a technical issue associated with the user.

In some examples, identifying the plurality of AI agents may include providing, prior to receiving the user query, one or more discovery prompts requesting identification of the plurality of AI agents, and receiving one or more discovery responses that identify the plurality of AI agents and comprise, for each respective AI agent of the plurality of AI agents, corresponding one or more attribute values that represent a corresponding capability of the respective AI agent. The multi-agent controller may be configured to route one or more communications related to the user query between the plurality of AI agents based on the corresponding capabilities of the plurality of AI agents.

In some examples, the one or more discovery prompts may include a plurality of discovery prompts. The one or more discovery responses may include a plurality of discovery responses. Providing the plurality of discovery prompts may include (i) providing, to the first platform, a first discovery prompt requesting identification of first one or more AI agents available on the first platform and (ii) providing, to the second platform, a second discovery prompt requesting identification of second one or more AI agents available on the second platform. Receiving the plurality of discovery responses may include (i) receiving, from the first platform, a first discovery response identifying the first one or more AI agents and (ii) receiving, from the second platform, a second discovery response identifying the second one or more AI agents. Identifying the plurality of AI agents may include (i) determining, based on the first discovery response, a first representation of the corresponding capabilities of the first one or more AI agents available on the first platform and (ii) determining, based on the second discovery response, a second representation of the corresponding capabilities of the second one or more AI agents available on the second platform. The multi-agent controller may be configured to route one or more communications related to the user query between the plurality of AI agents based on the first representation and the second representation.

In some examples, the one or more discovery prompts may include an unstructured textual string. The one or more discovery responses may include a plurality of key-value pairs that (i) are arranged according to a data serialization format and (ii) define the corresponding one or more attribute values of each respective AI agent.

In some examples, the corresponding one or more attribute values of each respective AI agent may include one or more of: an identifier of the respective AI agent, a textual description of an operation that the respective AI agent is configured to perform, a representation of a software tool that the respective AI agent is configured to use, or a representation of an AI agent team to which the respective AI agent belongs.

In some examples, the plurality of AI agents may include a plurality of AI agent teams. The plurality of AI agent teams may include (i) a first AI agent team provided by the first platform and comprising a first plurality of AI agents that includes the first AI agent and (ii) a second AI agent team provided by the second platform and comprising a second plurality of AI agents that includes the second AI agent.

In some examples, the first AI agent may include a first plurality of AI agents. A first communication may be routed between the multi-agent controller and the first plurality of AI agents through a first coordinator agent that may be configured to control at least some operations of the first plurality of AI agents. The second AI agent may include a second plurality of AI agents. A second communication may be routed between the multi-agent controller and the second plurality of AI agents through a second coordinator agent that may be configured to control at least some operations of the second plurality of AI agents. The first coordinator agent and the second coordinator agent may be configured to determine a plan for using the plurality of AI agents to respond to the user query.

In some examples, the user query may be specified by a user associated with the first platform and may indicate a technical problem to be resolved by the plurality of AI agents on behalf of the user.

In some examples, the output data may include (i) a suggested action to be taken by one or more AI agents of the plurality of AI agents to address the user query and (ii) a request for approval of execution of the suggested action. The request may be provided for approval to a user associated with the user query. User authorization to execute the suggested action may be received. The user authorization may be routed to the one or more AI agents to cause execution of the suggested action.

In some examples, the user query may be associated with a non-textual artifact. The non-textual artifact may be processed by at least one AI agent of the plurality of AI agents to facilitate generation of the output data.

In some examples, the output data may include a history of interactions performed among the plurality of AI agents to facilitate generation of the output data.

### XI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
at a multi-agent controller:
receiving a user query;
identifying a plurality of artificial intelligence (AI) agents for responding to the user query, wherein the plurality of AI agents comprises (i) a first AI agent associated with a first platform and (ii) a second AI agent associated with a second platform that is different from the first platform; and
generating, based on operations of the plurality of AI agents, output data responsive to the user query.

2. The method of claim 1, further comprising:
routing, using the multi-agent controller and between the plurality of AI agents, one or more communications representing intermediate results generated by the plurality of AI agents in responding to the user query.

3. The method of claim 2, wherein the one or more communications comprise an instruction configured to cause at least one AI agent of the plurality of AI agents to use a software tool available to the at least one AI agent.

4. The method of claim 2, wherein:
identifying the plurality of AI agents comprises selecting the first AI agent based on the user query,
routing the one or more communications comprises: (i) providing a first request to the first AI agent based on the user query and (ii) receiving, from the first AI agent, a first response to the first request and representing a first intermediate result generated by the first AI agent,
identifying the plurality of AI agents comprises selecting the second AI agent based on the first response, and
routing the one or more communications comprises: (i) providing, to the second AI agent, a second request based on the first response and (ii) receiving, from the second AI agent, a second response to the second request and representing a second intermediate result generated by the second AI agent.

5. The method of claim 4, wherein:
each of the first request and the second request specifies a data serialization format used by the plurality of AI agents in generating and processing the one or more communications,
each of the first request, the second request, the first response, and the second response is represented using the data serialization format,
each of the first AI agent and the second AI agent is configured to process, respectively, the first request and the second request as represented using the data serialization format,
each of the first AI agent and the second AI agent is configured to generate, respectively, the first response and the second response structured according to the data serialization format.

6. The method of claim 4, wherein:
each respective request of the first request and the second request includes one or more key-value pairs specifying attributes of one or more of:
a sender AI agent of the respective request;
a recipient AI agent of the respective request;
a task to be performed by the recipient AI agent;
a context data associated with the user query;
an input data artifact associated with the user query;
a user that provided the user query; or
a software tool available to the sender AI agent; and
each respective response of the first response and the second response includes one or more further key-value pairs specifying attributes of one or more of:
an output of the task as performed by the recipient AI agent based on the respective request;
an output data artifact generated by the recipient AI agent;
a suggested follow-up task to be performed by one or more AI agents of the plurality of AI agents; or
a further software tool requested to be executed on behalf of the recipient AI agent.

7. The method of claim 1, further comprising:
generating, based on the output data, a graphical user interface that indicates a response to the user query.

8. The method of claim 1, wherein the first platform is provided by a first computing system, wherein the second platform is provided by a second computing system, and wherein the first computing system is different from the second computing system.

9. The method of claim 1, wherein the first platform comprises a remote network management platform, wherein the second platform comprises a third-party platform disposed outside of the remote network management platform, and wherein the plurality of AI agents are configured to communicate using a common data format specified by the remote network management platform.

10. The method of claim 1, wherein the plurality of AI agents are configured to process context data associated with the user query, wherein the multi-agent controller is configured to provide the context data to the plurality of AI agents, and wherein the context data comprises one or more of:
an attribute of a user that provided the user query;
memory data associated with at least one of the user query or a prior user query provided by the user;
a user preference specified by the user for executing the plurality of AI agents;
a current page viewed by the user; or
an alert representing a technical issue associated with the user.

11. The method of claim 1, wherein identifying the plurality of AI agents comprises:
providing, prior to receiving the user query, one or more discovery prompts requesting identification of the plurality of AI agents; and
receiving one or more discovery responses that identify the plurality of AI agents and comprise, for each respective AI agent of the plurality of AI agents, corresponding one or more attribute values that represent a corresponding capability of the respective AI agent, wherein the multi-agent controller is configured to route one or more communications related to the user query between the plurality of AI agents based on the corresponding capabilities of the plurality of AI agents.

12. The method of claim 11, wherein:
the one or more discovery prompts comprise a plurality of discovery prompts,
the one or more discovery responses comprise a plurality of discovery responses,
providing the plurality of discovery prompts comprises (i) providing, to the first platform, a first discovery prompt requesting identification of first one or more AI agents available on the first platform and (ii) providing, to the second platform, a second discovery prompt requesting identification of second one or more AI agents available on the second platform,
receiving the plurality of discovery responses comprises (i) receiving, from the first platform, a first discovery response identifying the first one or more AI agents and (ii) receiving, from the second platform, a second discovery response identifying the second one or more AI agents,
identifying the plurality of AI agents comprises (i) determining, based on the first discovery response, a first representation of the corresponding capabilities of the first one or more AI agents available on the first platform and (ii) determining, based on the second discovery response, a second representation of the corresponding capabilities of the second one or more AI agents available on the second platform, wherein the multi-agent controller is configured to route the one or more communications related to the user query between the plurality of AI agents based on the first representation and the second representation.

13. The method of claim 11, wherein the one or more discovery prompts comprise an unstructured textual string, and wherein the one or more discovery responses comprise a plurality of key-value pairs that (i) are arranged according to a data serialization format and (ii) define the corresponding one or more attribute values of each respective AI agent.

14. The method of claim 11, wherein the corresponding one or more attribute values of each respective AI agent comprise one or more of:
an identifier of the respective AI agent;
a textual description of an operation that the respective AI agent is configured to perform;
a representation of a software tool that the respective AI agent is configured to use; or
a representation of an AI agent team to which the respective AI agent belongs.

15. The method of claim 1, wherein the plurality of AI agents comprises a plurality of AI agent teams, wherein the plurality of AI agent teams comprises (i) a first AI agent team provided by the first platform and comprising a first plurality of AI agents that includes the first AI agent and (ii) a second AI agent team provided by the second platform and comprising a second plurality of AI agents that includes the second AI agent.

16. The method of claim 1, wherein the first AI agent comprises a first plurality of AI agents, wherein a first communication is routed between the multi-agent controller and the first plurality of AI agents through a first coordinator agent configured to control at least some operations of the first plurality of AI agents, wherein the second AI agent comprises a second plurality of AI agents, wherein a second communication is routed between the multi-agent controller and the second plurality of AI agents through a second coordinator agent configured to control at least some operations of the second plurality of AI agents, and wherein the first coordinator agent and the second coordinator agent are configured to determine a plan for using the plurality of AI agents to respond to the user query.

17. The method of claim 1, wherein the output data comprises (i) a suggested action to be taken by one or more AI agents of the plurality of AI agents to address the user query and (ii) a request for approval of execution of the suggested action, and wherein the method further comprises:
providing the request for approval to a user associated with the user query;
receiving user authorization to execute the suggested action; and
routing the user authorization to the one or more AI agents to cause execution of the suggested action.

18. The method of claim 1, wherein the user query is associated with a non-textual artifact and wherein the non-textual artifact is processed by at least one AI agent of the plurality of AI agents to facilitate generation of the output data.

19. A system comprising a processor configured to perform operations comprising:
receiving, using a multi-agent controller, a user query;
identifying, using the multi-agent controller, a plurality of artificial intelligence (AI) agents for responding to the user query, wherein the plurality of AI agents comprises (i) a first AI agent associated with a first platform and (ii) a second AI agent associated with a second platform that is different from the first platform; and
generating, using the multi-agent controller and based on operations of the plurality of AI agents, output data responsive to the user query.

20. A non-transitory computer-readable storage medium having stored thereon instructions that, when executed by a computing device, cause the computing device to perform operations comprising:
receiving, using a multi-agent controller, a user query;
identifying, using the multi-agent controller, a plurality of artificial intelligence (AI) agents for responding to the user query, wherein the plurality of AI agents comprises (i) a first AI agent associated with a first platform and (ii) a second AI agent associated with a second platform that is different from the first platform; and
generating, using the multi-agent controller and based on operations of the plurality of AI agents, output data responsive to the user query.
